(19) United States
(12) Patent Application Publication
(10) Pub. No.: US 2021/0276307 A1
(43) Pub. Date: Sep. 9, 2021

(54) FUNCTIONAL FILM AND FUNCTIONAL LAMINATED GLASS

(71) Applicant: AGC Inc., Tokyo (JP)

(72) Inventors: Yoshinori IGUCHI, Tokyo (JP); Yukihiro TAO, Tokyo (JP); Yoko MITSUI, Tokyo (JP)

(73) Assignee: AGC Inc., Tokyo (JP)

(21) Appl. No.: 17/329,434

(22) Filed: May 25, 2021

Related U.S. Application Data
(63) Continuation of application No. PCT/JP2019/051009, filed on Dec. 25, 2019.

(30) Foreign Application Priority Data
Dec. 26, 2018 (JP) 2018-243655

(51) Int. Cl. B32B 17/10; B32B 7/12; B32B 7/023

(52) U.S. Cl. CPC B32B 17/10935; B32B 17/1022; B32B 17/10688; B32B 17/1044; B32B 7/12; B32B 7/023; B32B 2307/748; B32B 2307/412; B32B 2307/306; B32B 2307/418; B32B 2457/20; B32B 2255/20; B32B 2255/10; B32B 17/10036

(57) ABSTRACT

To provide a functional film with which a functional laminated glass excellent in adhesion between layers can be obtained, and a functional laminated glass excellent in adhesion between layers.

A functional film (transmission image display film 10) comprising a substrate film (transparent film 11) and a functional layer (light scattering layer 12) containing an organic material, which has a deposited layer (first deposited layer 13, second deposited layer 14, third deposited layer 15) formed of an inorganic oxide having an isoelectric point of at most 6 or at least 7.4 as measured by streaming potential method, either one of or both on the outermost surface of the functional film and between the substrate film and the functional layer.

### TECHNICAL FIELD

The present invention relates to a functional film and a functional laminated glass having a functional film.

### BACKGROUND ART

As a functional laminated glass having a functional film sandwiched between two transparent substates, the following have been known.
A transparent screen having an image display film having an image display layer laminated on a substrate film, sandwiched between two transparent substrates via adhesive layers (Patent Documents 1 and 2).
A heat reflective laminated glass having a heat reflective film having a heat reflective layer laminated on a substrate film, sandwiched between two transparent substrates via adhesive layers (Patent Documents 3 to 5).
A design laminated glass having a design film having a design layer with e.g. patterns laminated on a substrate film, sandwiched between two transparent substrates via adhesive layers (Patent Documents 6 and 7).

### PRIOR ART DOCUMENTS

### Patent Documents

Patent Document 1: WO2015/186630

Patent Document 2: WO2015/186668

Patent Document 3: Japanese Patent No. 4848872

Patent Document 4: JP-A-2010-222233

Patent Document 5: WO2013/168714

Patent Document 6: JP-A-H08-157239

Patent Document 7: JP-A-2009-078962

### DISCLOSURE OF INVENTION

### Technical Problem

A functional laminated glass is produced by laminating a glass plate, an interlayer functioning as an adhesive layer, a functional film, an interlayer functioning as an adhesive layer, and a glass plate in this order, and heating the laminate to bond the respective layers.

However, if a functional layer (an image display layer, a heat reflective layer, a design layer, or the like) contains an organic material, depending upon the material of the adhesive layer or the substrate film, adhesion of the interface between the functional layer and the adhesive layer or of the interface between the functional layer and the substrate film may be insufficient. Further, depending upon the material of the adhesive layer or the substrate film, adhesion of the interface between the adhesive layer and the substrate film may be insufficient.

The present invention provides a functional film with which a functional laminated glass excellent in adhesion between layers can be obtained, and a functional laminated glass excellent in adhesion between layers.

### Solution to Problem

The present invention has the following embodiments.

<1> A functional film comprising a substrate film and a functional layer containing an organic material, which has a deposited layer formed of an inorganic oxide having an isoelectric point of at most 6 or at least 7.4 as measured by streaming potential method, either one of or both on the outermost surface of the functional film and between a substrate film and the functional layer.
<2> The functional film according to <1>, which has the deposited layer both on the outermost surface of the functional film and between the substrate film and the functional layer.
<3> The functional film according to <1> or <2>, wherein the deposited layer has a thickness of at most 100 nm.
<4> The functional film according to any one of <1> to <3>, wherein the deposited layer is a single layer.
<5> The functional film according to any one of <1> to <4>, wherein the inorganic oxide is at least one member selected from the group consisting of α-Al₂O₃, γ-Al₂O₃, CuO, NiO, SiO₂ and TiO₂.
<6> The functional film according to any one of <1> to <5>, wherein the functional layer is at least one member selected from the group consisting of an image display layer, a heat reflective layer, a design layer, a protective layer, an ultraviolet absorbing layer, a light controlling layer and a polymer dispersed liquid crystal layer.
<7> A functional laminated glass, comprising a first transparent substrate, a first adhesive layer, the functional film as defined in any one of <1> to <6>, a second adhesive layer and a second transparent substrate, laminated in this order.
<8> The functional laminated glass according to <7>, wherein the first adhesive layer and the second adhesive layer comprise at least one member selected from the group consisting of a polyvinyl acetal resin, an ethylene/vinyl acetate copolymer, an ionomer and a cycloolefin polymer.
<9> The functional laminated glass according to <7> or <8>, wherein the peel adhesion of the interface between the deposited layer and the first adhesive layer or the second adhesive layer, obtained in accordance with JIS A 5759 (2016), is at least 4 N/25 mm.

### Advantageous Effects of Invention

According to the functional film of the present invention, a functional laminated glass excellent in adhesion between layers can be obtained.

The functional laminated glass of the present invention is excellent in adhesion between layers.

### BRIEF DESCRIPTION OF DRAWINGS

FIG. 1 is a cross sectional view illustrating an example of a transmission image display film according to a first embodiment of the functional film of the present invention.

FIG. 2 is a cross sectional view illustrating an example of a reflective image display film according to a second embodiment of the functional film of the present invention.

FIG. 3 is a cross sectional view illustrating an example of a process for producing a reflective image display film.

FIG. 4 is a cross sectional view illustrating an example of a heat reflective film according to a third embodiment of the functional film of the present invention.

FIG. 5 is a cross sectional view illustrating an example of a design film according to a fourth embodiment of the functional film of the present invention.

FIG. 6 is a layer structure view illustrating an example of a transmission transparent screen according to a first embodiment of the functional laminated glass of the present invention.

FIG. 7 is a layer structure view illustrating an example of a reflective transparent screen according to a second embodiment of the functional laminated glass of the present invention.

FIG. 8 is a layer structure view illustrating an example of a heat reflective laminated glass according to a third embodiment of the functional laminated glass of the present invention.

FIG. 9 is a layer structure view illustrating an example of a design laminated glass according to a fourth embodiment of the functional laminated glass of the present invention.

FIG. 10 is a flow chart illustrating a process for producing a functional laminated glass according to an embodiment.

FIG. 11 is a cross sectional view illustrating a modified example of the reflective image display film shown in FIG. 2.

FIG. 12 is a layer structure view illustrating a modified example of the reflective transparent screen shown in FIG. 7.

### DESCRIPTION OF EMBODIMENTS

The following definition of terms are applicable throughout description and claims. The “isoelectric point” means the pH of an aqueous solution when the charge of an ampholyte (inorganic oxide) in the aqueous solution as a whole is 0. As the isoelectric point, the pH when the zeta potential becomes 0 which is measured by electrokinetic potential measurement (streaming potential method) while changing the pH of the aqueous solution.

A “first surface” means an outermost surface of an image display film or a transparent screen, on the side from which image light emitted from a projector enters.

A “second surface” means an outermost surface of an image display film or a transparent screen, on the opposite side from the first surface.

A “sight on the first surface side (second surface side)” means an image observed over the image display film or the transparent screen as viewed by an observer on the second surface side (first surface side) of the image display film or the transparent screen. The sight does not include an image formed by image light emitted from a projector on the image display film or the transparent screen.

An “uneven structure” means an uneven structure formed of a plurality of protrusions, a plurality of recesses, or a plurality of protrusions and recesses.

An “irregular uneven structure” means an uneven structure in which protrusions or recesses do not periodically appear, and the sizes of the protrusions or recesses are not uniform.

A “film” may be in a sheet form or may be in a continuous strip form.

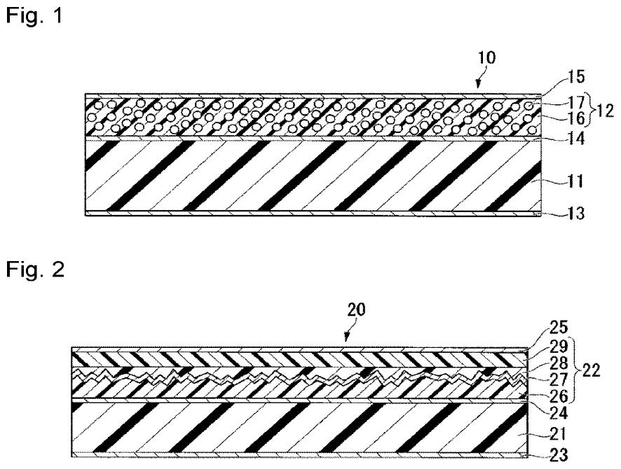

The dimensional ratios in FIGS. 1 to 9, 11 and 12 are different from actual ones for convenience of explanation.

### <Functional Film>

The functional film of the present invention has at least one functional layer containing an organic material. The at least one functional layer is preferably formed on a substrate film.

The functional film of the present invention has a specific deposited layer either one of or both on the outermost layer of the functional film and between the substrate film and the functional layer. The functional film of the present invention preferably has a specific deposited layer both on the outermost surface of the functional film and between the substrate film and the functional layer, whereby more excellent adhesion between the respective layers will be obtained.

The substrate film may be a single-layer film or a laminated film. As the substrate film, usually, a transparent film is used. The transparent film is preferably an oriented film, more preferably a biaxially oriented film, which has mechanical strength.

As the material of the substrate film, for example, a polyester (such as polyethylene terephthalate (hereinafter referred to as “PET”) or polyethylene naphthalate), polypropylene, polymethyl methacrylate, polycarbonate, triacetyl cellulose, polyvinyl alcohol, polyether ether ketone, or a cycloolefin polymer (hereinafter referred to as “COP”) may be mentioned.

The functional layer may, for example, be an image display layer, a heat reflective layer, a design layer, a protective layer, an ultraviolet absorbing layer, a light controlling layer or a polymer dispersed liquid crystal layer.

The functional layer in the present invention contains an organic material. The organic material may, for example, be a resin (such as a thermoplastic resin or a cured product of a curable resin).

The functional layer may contain an inorganic material. The inorganic material may, for example, be a metal, a metal oxide, glass, quartz, ceramic or a carbon-based material (such as carbon black).

The image display layer containing an organic material may, for example, be a light scattering layer having a light scattering material dispersed in a transparent resin, or a light scattering layer having a reflective film with an irregular uneven structure embedded in a transparent resin layer.

The heat reflective layer containing an organic material may, for example, be a layer having a high refractive index layer containing a high refractive index organic material and a low refractive index layer containing a low refractive index organic material alternately laminated.

The design layer containing an organic material may, for example be a printed layer formed by printing an optional design with a print ink on a substrate film.

The protective layer containing an organic material is a layer formed on the outermost surface of the functional film to protect the surface of other functional layer or the surface of the substrate film. The protective film containing an organic material may, for example, be a hard coat layer formed of a cured product of a curable resin.

The deposited layer is a layer formed by depositing an inorganic oxide. The inorganic oxide may, for example, be a metal oxide or an oxide of a semimetal.

The isoelectric point of the inorganic oxide is preferably at most 6 or at least 7.4, preferably at least 9, whereby the deposited layer has high polarity and will be excellent in adhesion to the adjacent layer.

The inorganic oxide having an isoelectric point of at most 6 or at least 7.4 may, for example, be α-Al₂O₃ (9.1 to 9.2 (sp)), γ-Al₂O₃ (7.4 to 8.6 (sp)), CuO, NiO, SiO₂ (quartz) (2.2 to 2.8 (sp)), TiO₂ (natural rutile) (5.5 (sp)).

The numerical values in brackets are the isoelectric points described in “Zeta-potential Measurements”, Kunio Furusawa, Bunseki (Analysis), May 2004, The Japan Society for Analytical Chemistry, pages 247 to 254, and the isoelectric points measured by streaming potential method of electrokinetic measurement are extracted and represented with sp.

By the way, as an inorganic oxide having an isoelectric point of higher than 6 and less than 7.4, for example, Cr₂O₃ (hydrate), SnO₂ and TiO₂ (synthetic rutile) (6.7 (sp)) may be mentioned.

The thickness of the deposited layer is, from the economical viewpoint, preferably at most 100 nm, more preferably at most 50 nm, further preferably at most 20 nm, particularly preferably at most 5 nm. The lower limit value of the thickness of the deposited layer is not particularly limited, and with a view to forming a homogeneous deposited layer, the thickness of the deposited layer is preferably at least 1 nm.

In order to make the deposited layer thin and to achieve more excellent adhesion to the adjacent layer, the deposited layer is preferably a single layer.

The functional film may, for example be in the form of an image display film having an image display layer, a heat reflective film having a heat reflective layer, or a design film having a design layer.

The image display film is a film through which a sight over the film can be seen, and which visibly displays image light projected on the film as an image. Specifically, it is a film having a first surface and a second surface on the opposite side from the first surface, through which a sight on the first surface side is visibly transmitted to an observer on the second surface side, through which a sight on the second surface side is visibly transmitted to an observer on the first surface side, and which visibly displays image light projected from a projector located on the first surface side as an image for either one of an observer on the first surface side and an observer on the second surface side.

The image display film may be a transmission image display film which visibly displays image light projected from the first surface side as an image for an observer on the second surface side, or may be a reflective image display film which visibly displays image light projected from the first surface side as an image for an observer on the first surface side.

Now, an embodiment of the functional film of the present invention will be described.

### (Transmission Image Display Film)

FIG. 1 is a cross sectional view illustrating an example of a transmission image display film according to a first embodiment of the functional film of the present invention.

The transmission image display film 10 comprises a transparent film 11, a light scattering layer 12, a first deposited layer 13 formed on the surface of the transparent film 11 on the opposite side from the light scattering layer 12, a second deposited layer 14 formed between the transparent film 11 and the light scattering layer 12, and a third deposited layer 15 formed on the surface of the light scattering layer 12 on the opposite side from the transparent film 11.

As the transparent film 11, the same one as the above substrate film may be mentioned, and preferred embodiments are also the same.

As the first deposited layer 13, the second deposited layer 14 and the third deposited layer 15, the same one as the above deposited layer may be mentioned, and preferred embodiments are also the same.

The light scattering layer 12 is a layer having a light scattering material 17 dispersed in a transparent resin 16. The light scattering layer 12 may contain a light absorbing material.

The transparent resin 16 may, for example, be a cured product of a photocurable resin (such as an acrylic resin or an epoxy resin), a cured product of a thermosetting resin (such as an acrylic resin or an epoxy resin), a thermoplastic resin (such as a polyester, an acrylic resin, a polyolefin, COP, a polycarbonate, a polyimide, a urethane resin, an ionomer, a polyvinyl acetal resin (such as polyvinyl butyral (hereinafter referred to as “PVB”)), an ethylene/vinyl acetate copolymer (hereinafter referred to as “EVA”), a fluororesin or a silicone resin.

The light scattering material 17 may, for example, be fine particles of a high refractive index material (e.g. titanium oxide (refractive index: 2.5 to 2.7), zirconium oxide (refractive index: 2.4), aluminum oxide (refractive index: 1.76)), fine particles of a low refractive index material (e.g. porous silica (refractive index: at most 1.3), hollow silica (refractive index: at most 1.3)), a resin material having low compatibility with and differing in the refractive index with the transparent resin 16, or a crystallized resin material of 1 μm or smaller. The light scattering material 17 is particularly preferably titanium oxide or zirconium oxide, which has a high refractive index.

The light absorbing material may, for example, be a carbon-based material (such as carbon black, titanium black, nanodiamond, fullerene, carbon nanotubes, carbon nanohorns of graphene), black silica, fine particles of a material in which the silver content is the highest among metal elements, or an organic dye.

The transmission image display film 10 may be produced, for example, by a process comprising the following steps A1 to A3.

Step A1: An inorganic oxide is physically deposited on both sides of a transparent film 11 to form a first deposited layer 13 and a second deposited layer 14.

Step A2: A coating fluid containing a solvent, a thermoplastic resin and a light scattering material 17 is applied to the surface of the second deposited layer 14 and dried to form a light scattering layer 12. Otherwise, a coating fluid containing a solvent, a photocurable resin and a light scattering material 17 is applied to the surface of the second deposited layer 14 and dried to form an uncured film, another transparent film is overlaid on the uncured film, and the uncured film is irradiated with ultraviolet rays or the like to cure the photocurable resin thereby to form a light scattering layer 12.

Step A3: An inorganic oxide is physically deposited on the surface of the light scattering layer 12 to form a third deposited layer 15.

As a method of applying the coating fluid, for example, die coating method, blade coating method, gravure coating method, ink jet method or spray coating method may be mentioned.

The physical deposition method may, for example, be vacuum deposition method or sputtering method.

The transmission image display film is not limited to the transmission image display film 10 shown in the drawing.

For example, within a range where adhesion is not impaired, one or two of the first deposited layer, the second deposited layer and the third deposited layer may be omitted.

Further, the transparent film may be provided on both sides of the light scattering layer. In this case, the first deposited layer and the third deposited layer are formed on the surface of the transparent film. Further, the second deposited layer is formed on both sides of the light scattering layer.

Further, the image display layer of the transmission image display film may be a light scattering layer comprising a transparent layer and a plurality of light scattering portions disposed in parallel with one another at predetermined intervals in the inside of the transparent layer, as shown in FIG. 1 in Patent Document 1.

Further, the image display layer of the transmission image display film may be a light scattering layer comprising an uneven layer and a covering layer covering the protrusions and recesses on the surface of the uneven layer, as the screen sheet shown in FIG. 5 in JP-A-2017-102307.

### (Reflective Image Display Film)

FIG. 2 is a cross sectional view illustrating an example of a reflective image display film according to a second embodiment of the functional film of the present invention.

The reflective image display film 20 comprises a transparent film 21, a light scattering layer 22, a first deposited layer 23 formed on the surface of the transparent film 21 on the opposite side from the light scattering layer 22, a second deposited layer 24 formed between the transparent film 21 and the light scattering layer 22, and a third deposited layer 25 formed on the surface of the light scattering layer 22 on the opposite side from the transparent film 21.

As the transparent film 21, the same one as the above substrate film may be mentioned, and preferred embodiments are also the same.

As the first deposited layer 23, the second deposited layer 24 and the third deposited layer 25, the same one as the above deposited layer may be mentioned, and preferred embodiments are also the same.

The light scattering layer 22 comprises a first transparent resin layer 26 having an irregular uneven structure on its surface, formed on the surface of the second deposited layer 24; a reflective film 27 which transmits part of incident light, formed to follow the surface on the uneven structure side of the first transparent resin layer 26; a contact layer 28 formed to cover the surface of the reflective film 27; and a second transparent resin layer 29 formed to cover the surface of the contact layer 28.

As the materials of the first transparent resin layer 26 and the second transparent resin layer 29, a cured product of a photocurable resin, a cured product of a thermosetting resin, or a thermoplastic resin is preferred. The materials of the respective transparent resin layers may be the same or different, and are preferably the same.

The reflective film 27 is one which transmits part of light entering the reflective film 27 and which reflects the other part. The reflective film 27 may, for example, be a metal film, a semiconductor film, a dielectric monolayer film, a dielectric multilayer film, or a combination thereof.

As the material of the contact layer 28, for example, COP, an acrylic resin, a polyester, a urethane resin, a polycarbonate, PVB or EVA may be mentioned.

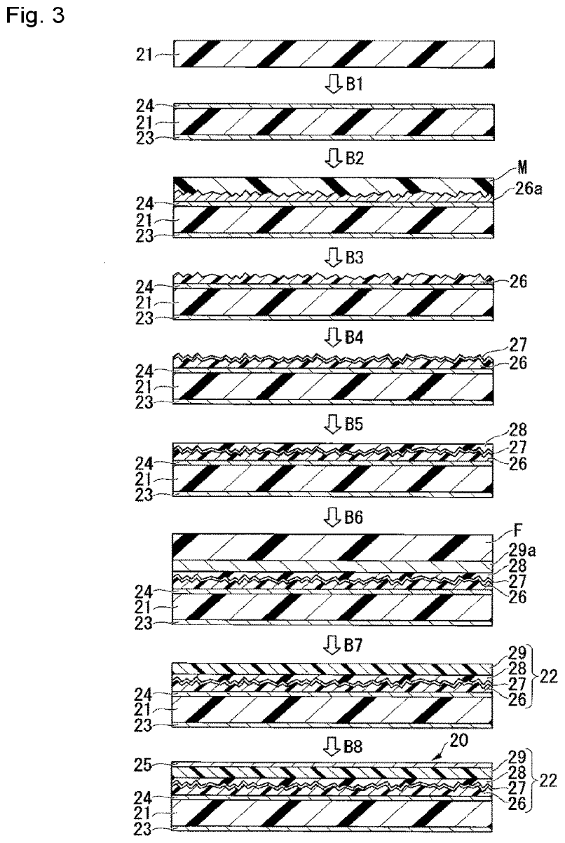

FIG. 3 is a cross sectional view illustrating an example of the process for producing the reflective image display film. The reflective image display film 20 may be produced, for example, by a process comprising the following steps B1 to B8.

Step B1: The inorganic oxide is physically deposited on both sides of a transparent film 21 to form a first deposited layer 23 and a second deposited layer 24.

Step B2: A coating fluid containing a solvent, a photocurable resin and the like is applied to the surface of the second deposited layer 24 and dried to form an uncured film 26a. A mold M having an irregular uneven structure formed on its surface is overlaid on the uncured film 26a so that the uneven structure is in contact with the uncured film 26a.

Step B3: The uncured film 26a is irradiated with ultraviolet rays or the like to cure the uncured film 26a thereby to form a first transparent resin layer 26 having the irregular uneven structure of the mold M transcribed on its surface. The mold M is separated from the first transparent resin layer 26.

Step B4: A metal is physically deposited on the surface of the first transparent resin layer 26 to form a reflective film 27 comprising a metal thin film.

Step B5: A coating fluid containing a solvent, a thermoplastic resin and the like is applied to the surface of the reflective film 27 and dried to form a contact layer 28. The contact layer 28 may follow the shape of the reflective layer 27.

Step B6: A coating fluid containing a solvent, a photocurable resin and the like is applied to the surface of the contact layer 28 and dried to form an uncured film 29a. A transparent release film F is overlaid on the uncured film 29a.

Step B7: The uncured film 29a is irradiated with ultraviolet rays or the like to cure the uncured film 29a, thereby to form a second transparent resin layer 29. The release film F is separated from the surface of the second transparent resin layer 29.

Step B8: An inorganic oxide is physically deposited on the surface of the second transparent resin layer 29 to form a third deposited layer 25.

The mold M may, for example, be a resin film having an irregular uneven structure formed on its surface. The resin film having an irregular uneven structure formed on its surface may, for example, be a resin film containing fine particles or a sand-blasted resin film.

The method of applying the coating fluid may, for example, be die coating method, blade coating method, gravure coating method, in jet method or spray coating method.

The physical deposition method may, for example, be vacuum deposition method or sputtering method.

The reflective image display film is not limited to the reflective image display film 20 shown in the drawing.

For example, within a range where adhesion is not impaired, one or two of the first deposited layer, the second deposited layer and the third deposited layer may be omitted.

Further, the transparent film may be provided on both sides of the light scattering layer. In this case, the first deposited layer and the third deposited layer are formed on the surface of the transparent film. Further, the second deposited layer is formed on both sides of the light scattering layer.

Further, the uneven structure on the surface of the first transparent resin layer may be a regular uneven structure (such as microlens arrays).

Further, when sufficient adhesion between the reflective film and the second transparent resin layer is obtained even without the contact layer, the contact layer may be omitted.

Further, when light can sufficiently be reflected and scattered by a refractive index difference between the first transparent resin layer and the contact layer or the second transparent resin layer, even without the reflective layer, the reflective layer may be omitted.

The image display layer of the reflective image display film may be a light scattering layer comprising a transparent material layer and a plurality of light reflecting particles aligned on one surface of the transparent material layer at intervals, as the screen sheet disclosed in JP-A-2017-102307, FIG. 3.

### (Heat Reflective Film)

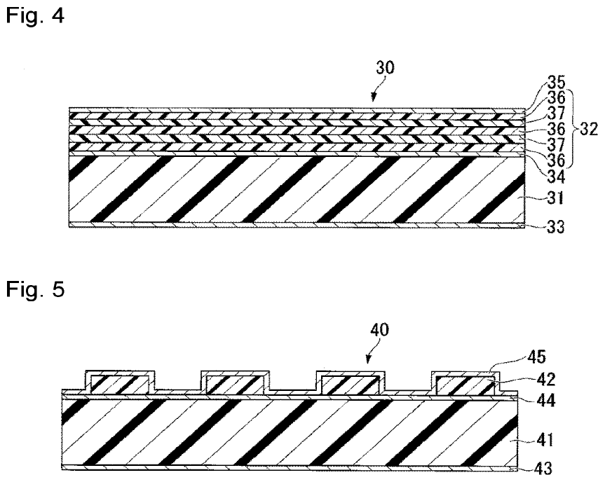

FIG. 4 is a cross sectional view illustrating an example of a heat reflective film according to a third embodiment of the functional film of the present invention.

The heat reflective film 30 comprises a transparent film 31, a heat reflective layer 32, a first deposited layer 33 formed on the surface of the transparent film 31 on the opposite side from the heat reflective layer 32, a second deposited layer 34 formed between the transparent film 31 and the heat reflective layer 32, and a third deposited layer 35 formed on the surface of the heat reflective layer 32 on the opposite side from the transparent film 31.

As the transparent film 31, the same one as the above substrate film may be mentioned, and preferred embodiments are also the same.

As the first deposited layer 33, the second deposited layer 34 and the third deposited layer 35, the same one as the above deposited layer may be mentioned, and preferred embodiments are also the same.

The heat reflective layer 32 is a layer having a high refractive index layer 26 and a low refractive index layer 26 alternately laminated. The form of the lamination of the high refractive index layer 36 and the low refractive index layer 37 is not limited to the one shown in the drawing.

As specific examples of the high refractive index layer 36 and the low refractive index layer 37, ones described in Patent Documents 3 to 5 may be mentioned.

The heat reflective film 30 may be produced, for example, by a process comprising the following steps C1 to C3.

Step C1: An inorganic oxide is physically deposited on both sides of a transparent film 31 to form a first deposited layer 33 and a second deposited layer 34.

Step C2: A high refractive index layer 36 and a low refractive index layer 37 are alternately formed on the surface of the second deposited layer 34.

Step C3: An inorganic oxide is physically deposited on the surface of the outermost high refractive index layer 36 to form a third deposited layer 35.

As a method of forming the high refractive index layer 36 and the low refractive index layer 37, for example, methods described in Patent Documents 3 to 5 may be mentioned.

The physical deposition method may, for example, be vacuum deposition method or sputtering method.

The heat reflective film is not limited to the heat reflective film 30 shown in the drawing.

For example, within a range where adhesion is not impaired, one or two of the first deposited layer, the second deposited layer and the third deposited layer may be omitted.

Further, on the surface of the transparent film, a hard coat layer may be formed. In this case, the first deposited layer is formed on the surface of the hard coat layer.

Further, a heat absorbing layer may further be provided. The heat absorbing layer may be a layer comprising a transparent film having an infrared absorbing agent blended.

### (Design Film)

FIG. 5 is a cross sectional view illustrating an example of a design film according to a fourth embodiment of the functional film of the present invention.

The design film 40 comprises a transparent film 41, a patterned printed layer 42, a first deposited layer 43 formed on the surface of the transparent film 41 on the opposite side from the printed layer 42, a second deposited layer 44 formed on the surface of the transparent film 41 on the printed layer 42 side, and a third deposited layer 45 formed on the surface of the printed layer 42 and the exposed surface of the second deposited layer 44.

As the transparent film 41, the same one as the above substrate film may be mentioned, and preferred embodiments are also the same.

As the first deposited layer 43, the second deposited layer 44 and the third deposited layer 45, the same one as the above deposited layer may be mentioned, and preferred embodiments are also the same.

The printed layer 42 is a layer having an optional design printed on the deposited layer-provided transparent film 41 with a print ink.

As specific examples of the printed layer 42, for example, ones described in Patent Documents 6 and 7 may be mentioned.

The design film 40 may be produced, for example, by a process comprising the following steps D1 to D3.

Step D1: An inorganic oxide is physically deposited on both sides of a transparent film 41 to form a first deposited layer 43 and a second deposited layer 44.

Step D2: On the surface of the second deposited layer 44, a printed layer 42 is formed.

Step D3: An inorganic oxide is physically deposited on the surface of the printed layer 42 and the expose surface of the second deposited layer 44 to form a third deposited layer 45.

As a method of forming the printed layer 42, for example, methods described in Patent Documents 6 and 7 may be mentioned.

The physical deposition method may, for example, be vacuum deposition method or sputtering method.

The design film is not limited to the design film 40 shown in the drawing.

For example, a protective layer may be formed on the surface of the printed layer. In this case, the third deposited layer is formed on the surface of the protective layer.

### (Mechanism of Action)

When the above functional film of the present invention, which has on its outermost surface a deposited layer formed of an inorganic oxide having an isoelectric point of at most 6 or at least 7.4, is used for a functional laminated glass, excellent adhesion between the functional film and an adhesive layer will be obtained. Further, when the functional film has, between the substrate film and the functional layer, a deposited layer formed of an inorganic oxide having an isoelectric point of at most 6 or at least 7.4, excellent adhesion between the substrate film and the functional layer will be obtained.

The functional film of the present invention is not limited so long as it is a functional film comprising a substrate film and a functional layer containing an organic material, which has a deposited layer formed of an inorganic oxide having an isoelectric point of at most 6 or at least 7.4, either one of or both on the outermost surface of the functional film and between the substrate film and the functional layer, and is not limited to the functional films according to the first to fourth embodiments shown in the drawings.

### <Functional Laminated Glass>

The functional laminated glass of the present invention comprises the functional film of the present invention sandwiched between two transparent substrates. The transparent substrate and the functional film are bonded by an adhesive layer.

The material of the transparent substrate may, for example, be glass or a transparent resin. The materials of the respective transparent substrates may be the same or different.

The glass constituting the transparent substrate may, for example, be soda lime glass, alkali free glass, borosilicate glass or aluminosilicate glass. The transparent substrate comprising glass may have chemical tempering, physical tempering, hard coating or the like applied thereto, to improve durability.

The transparent resin constituting the transparent substrate may, for example, be a polycarbonate, a polyester (such as PET or polyethylene naphthalate), triacetyl cellulose, COP, polymethyl methacrylate or a fluororesin.

The adhesive layer is to bond the transparent substrate and the functional film and may comprise, for example, a thermoplastic resin composition containing a thermoplastic resin as the main component. The thermoplastic resin to be used for the adhesive layer may be a thermoplastic resin which has been used for this type of application. The thermoplastic resin may, for example, be a polyvinyl acetal resin (such as PVB), a polyvinyl chloride resin, a saturated polyester resin, a polyurethane resin, an ethylene/vinyl acetate copolymer resin (such as EVA), an ethylene/ethyl acrylate copolymer resin, an ionomer (such as a material having an ethylene/methacrylic acid copolymer intermolecularly crosslinked by metal ions), or COP. The adhesive layer is preferably one containing PVB or EVA in view of heat resistance and weather resistance. The materials of the respective adhesive layers may be the same or different.

The functional laminated glass of the present invention may be produced by a method of laminating a first transparent substrate, an interlayer functioning as a first adhesive layer, the functional film of the present invention, an interlayer functioning as a second adhesive layer and a second transparent substrate in this order and heating the laminate to bond the respective layers.

In a case where the functional laminated glass has a large area, when the functional film is overlaid on the interlayer, a plurality of the functional films may be aligned along the plane direction.

The interlayer is preferably one containing PVB or EVA in view of heat resistance and weather resistance.

The interlayer is preferably one to be used for production of laminated glass, whereby laminating operation can readily be conducted.

The heating temperature at the time of bonding is preferably from 80 to 150° C., more preferably from 90 to 140° C. When the heating temperature is at least the lower limit value of the above range, embossments on the interlayer will disappear, and the haze can be suppressed. When the heating temperature is at most the upper limit value of the above range, excessive shrinkage of the functional film and the resulting formation of bubbles can be suppressed.

The heating time at the time of bonding is preferably from 30 to 90 minutes, more preferably from 45 to 75 minutes. When the heating time is at least the lower limit value of the above range, embossments on the interlayer will disappear, and the haze can be suppressed. When the heating time is at most the upper limit value of the above range, the productivity is high and such is economically preferred.

The laminate of the transparent substrates, the interlayers and the functional film may be put in a vacuum bag (rubber bag) and subjected to preliminary bonding in a hot air oven at a relatively low temperature in a vacuum, and then put in an autoclave and subjected to main bonding under an elevated pressure at a relatively high temperature.

The heating temperature at the time of preliminary bonding is preferably at least 80° C. and less than 120° C. The heating time for preliminary bonding is preferably from 30 to 90 minutes.

The heating temperature at the time of main bonding is preferably from 100 to 150° C. The heating time for main bonding is preferably from 30 to 120 minutes. The pressure at the time of main bonding is preferably from 0.6 to 2.0 MPa [abs].

The form of the functional laminated glass may, for example, be a transparent screen having an image display film sandwiched between two transparent substrates via adhesive layers, a heat reflective laminated glass having a heat reflective film sandwiched between two transparent substrates via adhesive layers, or a design laminated glass having a design film sandwiched between two transparent substrates via adhesive layers.

The transparent screen is a screen through which a sight over the screen can be seen, and which visibly displays image light projected on the screen as an image. Specifically, it is a screen having a first surface and a second surface on the opposite side from the first surface, through which a sight on the first surface side is visibly transmitted to an observer on the second surface side, through which a sight on the second surface side is visibly transmitted to an observer on the first surface side, and which visibly displays image light emitted from a projector located on the first surface side as an image for either one of an observer on the first surface side and an observer on the second surface side.

The transparent screen may be a transmission transparent screen which visibly displays image light projected from the first surface side as an image for an observer on the second surface side, or may be a reflective transparent screen which visibly displays image light projected from the first surface side as an image for an observer on the first surface side.

Now, embodiments of the functional laminated glass of the present invention will be described.

### (Transmission Transparent Screen)

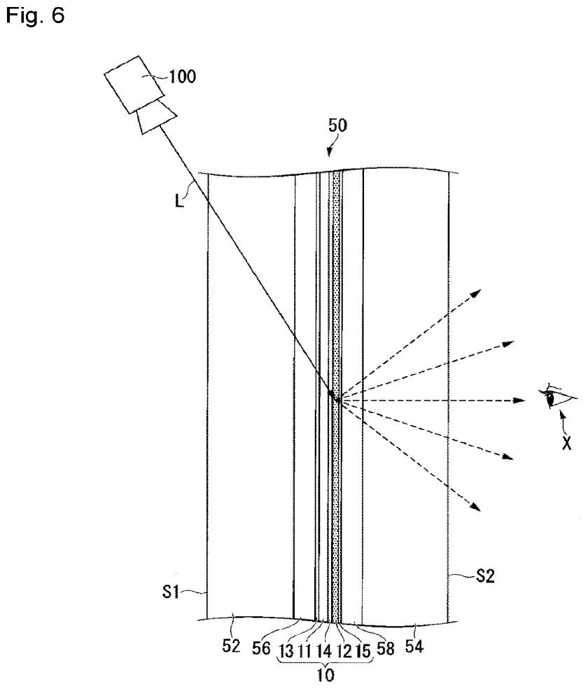

FIG. 6 is a layer structure view illustrating an example of a transmission transparent screen according to a first embodiment of the functional laminated glass of the present invention.

The transmission transparent screen 50 comprises a transmission image display film 10 disposed between a first transparent substrate 52 and a second transparent substrate 54.

The first transparent substrate 52 and the transmission image display film 10 are bonded by a first adhesive layer 56, and the second transparent substrate 54 and the transmission image display film 10 are bonded by a second adhesive layer 58.

As the material of the first transparent substrate 52 and the second transparent substrate 54, the same one as the transparent substrate of the above functional laminated glass may be mentioned, and preferred embodiments are also the same.

As the first adhesive layer 56 and the second adhesive layer 58, the same adhesive layer of the above functional laminated glass may be mentioned, and preferred embodiments are also the same.

In the transmission transparent screen 50, as shown in FIG. 6, image light L emitted from a projector 100 and entering the transmission transparent screen 50 from a first surface S1, is scattered by a light scattering layer 12 of the transmission image display film 10 to form an image, which is displayed visibly as an image for a second observer X on the side opposite from the projector 100.

Part of the light of a sight on the first surface S1 side is scattered by the light scattering layer 12 after entering the transmission transparent screen 50 from the first surface S1, and the rest is transmitted, whereby the second observer X on the second surface S2 side can recognize the sight on the first surface S1 side. Likewise, part of the light of a sight on the second surface S2 side is scattered by the light scattering layer 12 after entering the transmission transparent screen 50 from the second surface S2 side, and the rest is transmitted, whereby a first observer (not shown) on the first surface S1 side can recognize the sight on the second surface S2 side.

The projector 100 may be any one so long as it can emit image light L to the transmission transparent screen 50. The projector 100 may be any known projector and is preferably a short focus projector.

The transmission transparent screen is not limited to the transmission transparent screen 50 shown in the drawing.

For example, instead of the transmission image display film 10, the above transmission image display film according to other embodiment may be used.

Further, the transmission transparent screen may further have other layer. Such other layer may, for example, be a low reflective layer which reduces light reflection, a light attenuating layer which attenuates part of light, or an infrared shielding layer which blocks infrared rays.

### (Reflective Transparent Screen)

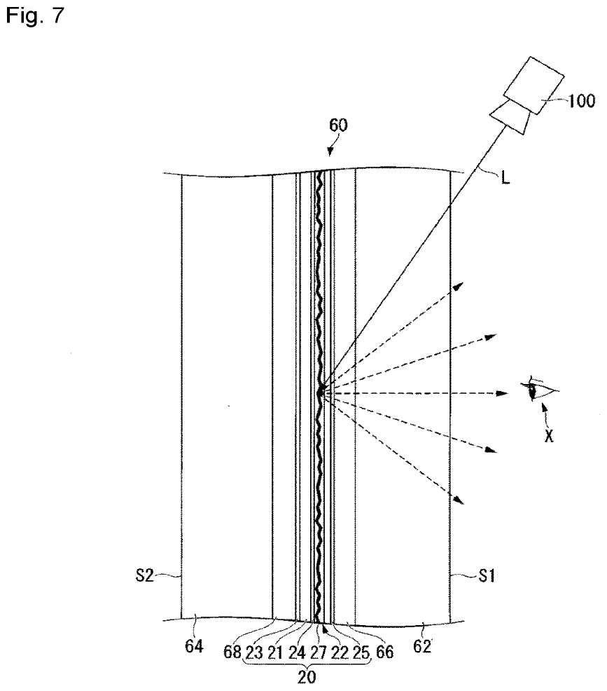

FIG. 7 is a layer structure view illustrating an example of a reflective transparent screen according to a second embodiment of the functional laminated glass of the present invention.

The reflective transparent screen 60 comprises a reflective image display film 20 disposed between a first transparent substrate 62 and a second transparent substrate 64.

The first transparent substrate 62 and the reflective image display film 20 are bonded by a first adhesive layer 66, and the second transparent substrate 64 and the reflective image display film 20 are bonded by a second adhesive layer 68.

In the following, members having the same constitution as in the transmission transparent screen 50 shown in FIG. 5 are referred to by the same reference symbols, and their descriptions are omitted.

As the material of the first transparent substrate 62 and the second transparent substrate 64, the same one as the transparent substrate of the above functional laminated glass may be mentioned, and preferred embodiments are also the same.

As the first adhesive layer 66 and the second adhesive layer 68, the same adhesive layer of the above functional laminated glass may be mentioned, and preferred embodiments are also the same.

In the reflective transparent screen 60, as shown in FIG. 7, image light L emitted from a projector 100 and entering the reflective transparent screen 60 from a first surface S1, is scattered by a reflective film 27 of the reflective image display film 20 to form aim image, which is displayed visibly as an image for a first observer X on the side of the projector 100.

Part of the light of a sight on the first surface S1 side is reflected on the reflective film 27 after entering the reflective transparent screen 60 from the first surface S1, and the rest is transmitted, whereby a second observer (not shown) on the second surface S2 side can recognize the sight on the first surface S1 side. Likewise, part of the light of a sight on the second surface S2 side is reflected on the reflective film 27 after entering the reflective transparent screen 60 from the second surface S2, and the rest is transmitted, whereby a first observer X on the first surface S1 side can recognize the sight on the second surface S2 side.

The reflective transparent screen is not limited to the reflective transparent screen 60 shown in the drawing.

For example, instead of the reflective image display film 20, the above reflective image display film according to other embodiment may be used.

Further, the reflective transparent screen may further have other layer. Such other layer may, for example, be a low reflective layer which reduces light reflection, a light attenuating layer which attenuates part of light, or an infrared shielding layer which shields infrared rays.

### (Heat Reflective Laminated Glass)

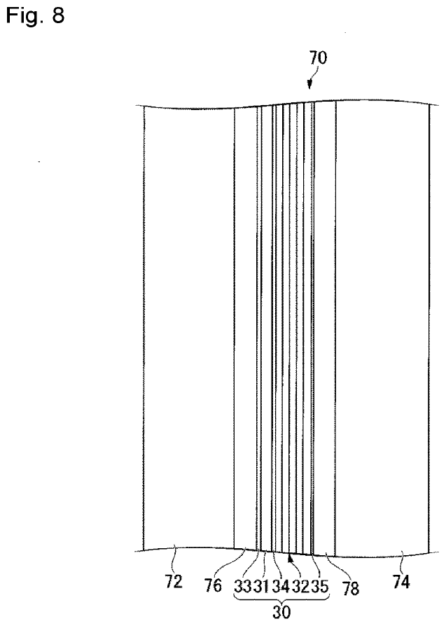

FIG. 8 is a layer structure view illustrating an example of a heat reflective laminated glass according to a third embodiment of the functional laminated glass of the present invention.

The heat reflective laminated glass 70 comprises a heat reflective film 30 disposed between a first transparent substrate 72 and a second transparent substrate 74.

The first transparent substrate 72 and the heat reflective film 30 are bonded by a first adhesive layer 76, and the second transparent substrate 74 and the heat reflective film 30 are bonded by a second adhesive layer 78.

As the material of the first transparent substrate 72 and the second transparent substrate 64, the same one as the transparent substrate of the above functional laminated glass may be mentioned, and preferred embodiments are also the same.

As the first adhesive layer 76 and the second adhesive layer 78, the same one as the adhesive layer of the above functional laminated glass may be mentioned, and preferred embodiments are also the same.

The heat reflective laminated glass is not limited to the heat reflective laminated glass 70 shown in the drawing.

For example, instead of the heat reflective film 30, the above heat reflective film according to other embodiment may be used.

### (Design Laminated Glass)

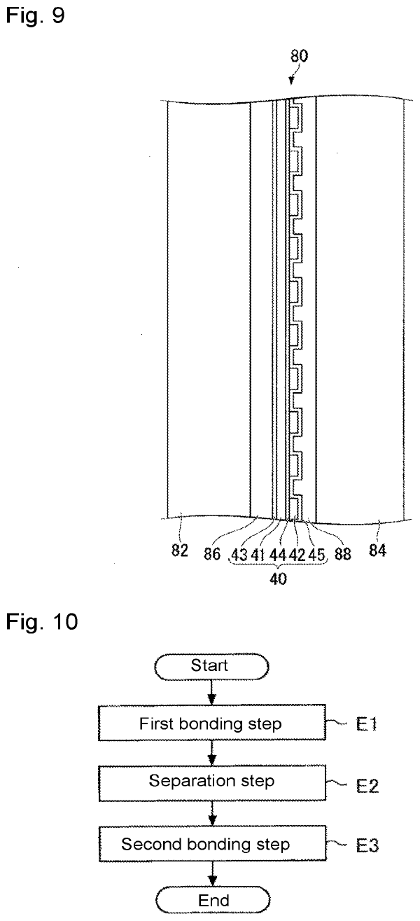

FIG. 9 is a layer structure view illustrating an example of a design laminated glass according to a fourth embodiment of the functional laminated glass of the present invention.

The design laminated glass 80 comprises a design film 40 disposed between a first transparent substrate 82 and a second transparent substrate 84.

The first transparent substrate 82 and the design film 40 are bonded by a first adhesive layer 86, and the second transparent substrate 84 and the design film 40 are bonded by a second adhesive layer 88.

As the material of the first transparent substrate 82 and the second transparent substrate 84, the same one as the transparent substrate of the above functional laminated glass may be mentioned, and preferred embodiments are also the same.

As the first adhesive layer 86 and the second adhesive layer 88, the same one as the adhesive layer of the above functional laminated glass may be mentioned, and preferred embodiments are also the same.

The design laminated glass is not limited to the design laminated glass 80 shown in the drawing.

For example, instead of the design film 40, the above design film according to other embodiment may be used.

### (Mechanism of Action)

When the above functional laminated glass of the present invention has, on the outermost surface of the functional film, a deposited layer formed of an inorganic oxide having an isoelectric point of at most 6 or at least 7.4, excellent adhesion between the functional film and the adhesive layer will be obtained. Further, when the functional laminated glass has, between the substrate film and the functional layer in the functional film, a deposited layer formed of an inorganic oxide having an isoelectric point of at most 6 or at least 7.4, excellent adhesion between the substrate film and the functional layer will be obtained.

The functional laminated glass of the present invention is not limited so long as it has a first transparent substrate, a first adhesive layer, the functional film of the present invention, a second adhesive layer and a second transparent substrate laminated in this order, and is not limited to the functional laminated glasses according to the first to fourth embodiments shown in the drawing.

The functional laminated glass of the present invention may be one having a region on which the functional film is present and a region on which the functional film is not present.

### <Process for Producing Functional Laminated Glass>

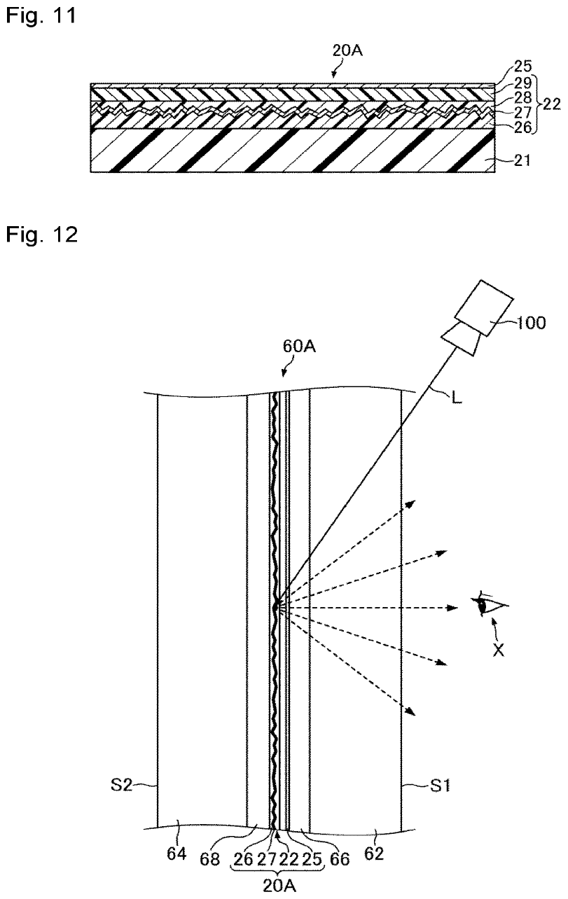

FIG. 10 is a flow chart illustrating a process for producing the functional laminated glass according to an embodiment. The process for producing the functional laminated glass preferably has First bonding step E1, Separation step E2 and Second bonding step E3 in this order. Now, as an example, steps in preparation of a reflective transparent screen 60A shown in FIG. 12 by forming a reflective image display film 20A shown in FIG. 11 as a modified example of the reflective image display film shown in FIG. 2 into a laminated glass, will be described.

FIG. 11 illustrates a reflective image display film 20A which is the same as the reflective image display film shown in FIG. 2 but differs in having no first deposited layer 23 and no second deposited layer 24.

First bonding step E1: A first adhesive layer 66 is heat-bonded on the third deposited layer 25 of the reflective image display film 20A to form a temporary laminate.

Separation step E2: The transparent film 21 is separated from the temporary laminate. After Separation step E2, the first transparent resin layer 26 of the light scattering layer 22 is exposed. In order that the transparent film 21 will readily be separated from the temporary laminate, a thermoplastic resin layer (for example, PVB layer having a thickness of from about 1 to about 10 μm, not shown) to control the adhesion between the transparent film 21 and the first transparent resin layer 26 may be provided.

Second bonding step E3: On the exposed first transparent resin layer 26, a second transparent substrate 64 is laminated via a second adhesive layer 68, and further, on the first adhesive layer 66, a first transparent substrate 62 is laminated to form a laminate. The laminate is subjected to heat bonding to obtain the reflective transparent screen 60A shown in FIG. 12.

The substrate film is a film used to form the functional layer and does not contribute to the development of the function. Accordingly, when the substrate film is to be separated at the time of preparation of the laminated glass, as shown in FIG. 11, the first deposited layer is not formed on the surface to be in contact with the substrate film (the transparent film 21) of the functional layer (the light scattering layer 22), and the third deposited layer 26 is formed only on the surface in contact with the first adhesive layer 66, whereby the transparent film 21 can readily be separated from the temporary laminate in Separation step E2.

For example, it is preferred that the peel adhesion between the substrate film and the functional layer is less than 4 N/25 mm and the peel adhesion between the functional layer and the first adhesive layer is at least 4 N/25 mm, whereby the transparent film 21 can readily be separated from the temporary laminate in Separation step E2. The peel adhesion between the functional layer and the first adhesive layer is more preferably at least 10 N/25 mm, further preferably at least 20 N/25 mm.

Further, a silane coupling agent may be applied to the surface of the first transparent resin layer 26 after the substrate film is separated, to increase the peel adhesion to the second adhesive layer 68.

### EXAMPLES

Now, the present invention will be described in further detail with reference to Examples. However, it should be understood that the present invention is by no means restricted to such specific Examples.

Ex. 1 to 5 are Examples of the present invention, and Ex. 6 to 10 are Comparative Examples.

### (Peel Adhesion Test)

A test specimen having a functional film, an adhesive layer and a glass plate laminated in this order was stabilized in an environment at 23±2° C. Cuts were made at 25 mm intervals on the functional film by a cutter knife, and the functional film was divided into 25 width strips. The functional film of each strip was peeled, and the adhesive layer and the glass plate portion was sandwiched by a lower chuck of a tensile test apparatus. The peeled portion of the functional film was folded back 180° and the functional film was peeled until it reached the upper chuck of the tensile test apparatus. The peeled portion of the functional film was sandwiched in an upper chuck of the tensile test apparatus. In accordance with JIS A 5759:2016, the functional film was peeled at 23±2° C. at a pulling rate of 300 mm/min, and the load and the displacement were measured. The loads were averaged with respect to a length of 60 mm with stabilized load and taken as the peel adhesion (N/25 mm). With respect to ten strips of the functional film, the peel adhesion was obtained, and the average was taken as a peel adhesion finally indicated. The peel adhesion was evaluated on the basis of the following evaluation standards. JIS A 5759:2016 specifies that the peel adhesion of a glass scattering prevention film should be at least 4.0 N/25 mm.

A: The peel adhesion is at least 20 N/25 mm.

B: The peel adhesion is at least 10 N/25 mm and less than 20 N/25 mm.

C: The peel adhesion is at least 4 N/25 mm and less than 10 N/25 mm.

D: The peel adhesion is less than 4 N/25 mm.

### (Adhesion Test)

With respect to a test specimen having a functional layer (coating film) formed on the surface of a substrate film directly or via a deposited layer, or with respect to a test specimen having a coating film formed on the surface of a functional film, adhesion of the coating film was evaluated by cross-cut test in accordance with JIS K 5600-5-6:1999 (corresponding international standards ISO 2409:1992).

As the blade of the cutter knife, a new one was always used. 11 cuts which would reach the base material were made at 1 mm intervals on the coating film, and the test specimen was turned around 90°, and 11 cuts were made in the same manner. An adhesive cellophane tape was bonded to the surface of the cut coating film so that the tape in a length of about 50 mm would be attached, and rubbed with an eraser to make the tape be attached to the coating film. 1 to 2 minutes after attachment of the tape, the edge of the tape was held to keep the tape at right angles to the coating film surface, and the tape was instantaneously peeled. The peel adhesion was evaluated on the basis of the following evaluation standards.

A: No grid cells peeled.

B: Peeling occurred, with a proportion of peeled cells of less than 15%.

C: The proportion of peeled cells being at least 15% and less than 35%.

D: The proportion of peeled cells being at least 35%.

### (Raw Materials)

A transparent PET film (biaxially oriented film, thickness 125 μm) was prepared.

30 Parts by mass of methyl ethyl ketone, 70 parts by mass of an ultraviolet curable resin and 3 parts by mass of a photoinitiator were mixed to obtain coating fluid 1.

90 Parts by mass of toluene and 10 parts by mass of COP were mixed to obtain coating fluid 2.

100 Parts by mass of ethanol, 10 parts by mass of a PVB powder, 0.1 part by mass of titanium oxide particles and 0.1 part by mass of carbon black were mixed to obtain coating fluid 3.

A glass plate (soda lime glass, thickness 3 mm) was prepared.

An interlayer 1 (PVB film, thickness 0.76 mm) was prepared.

An interlayer 2 (EVA film, thickness 0.8 mm) was prepared.

An interlayer 3 (ionomer film, thickness 0.89 mm) was prepared.

An interlayer 4 (COP film, thickness 0.8 mm) was prepared.

### Ex. 1

α-Al₂O₃ (isoelectric point: 9.1) was vacuum-deposited on both sides of the PET film to form a first deposited layer and a second deposited layer each having a thickness of 2 nm to obtain a double-deposited PET film 1.

The coating fluid 1 was applied to the surface of the second deposited layer of the double-deposited PET film 1, dried at 90° C. for 4 minutes, and irradiated with 1,000 mJ of ultraviolet rays to form a functional layer having a thickness of 10 μm thereby to obtain a functional film 1.

The functional film 1, the interlayer 1 and the glass plate were laminated in this order so that the first deposited layer of the functional film 1 and the interlayer 1 were in contact with each other, and the laminate was put in a vacuum bag and heated in a hot air oven at 100° C. under 0.015 MPa [abs] for 30 minutes in a vacuum to conduct preliminary bonding. The preliminarily bonded laminate was put in an autoclave and heated at 130° C. under 1.0 MPa [abs] for 60 minutes to conduct main bonding to obtain a laminate 1.

Laminates 2 to 4 were obtained in the same manner except that the interlayers 2 to 4 were used instead of the interlayer 1.

With respect to the laminates 1 to 4, the peel adhesion of the interface between the first deposited layer and the adhesive layer was evaluated. The results are shown in Table 1.

The coating fluid 2 was applied to the surface of the second deposited layer of the double-deposited PET film 1 and dried at 90° C. for 4 minutes to form a functional layer having a thickness of 5 μm thereby to obtain a functional film 2.

The coating fluid 3 was applied to the surface of the second deposited layer of the double-deposited PET film 1 and dried at 95° C. for 3 minutes to form a functional layer having a thickness of 5 μm thereby to obtain a functional film 3.

With respect to the functional films 1 to 3, the adhesion of the functional layer to the second deposited layer was evaluated. The results are shown in Table 1.

### Ex. 2

SiO₂ (isoelectric point: 2.2) was vacuum deposited on both sides of the PET film to form a first deposited layer and a second deposited layer each having a thickness of 2 nm to obtain a double-deposited PET film 2.

Functional films 1 to 3 and laminates 1 to 4 were obtained and evaluated in the same manner as in Ex. 1 except that the double-deposited PET film 2 was used. The results are shown in Table 1.

### Ex. 3

A functional film 1 was obtained in the same manner as in Ex. 1. On the surface of the functional layer of the functional film 1, CuO (isoelectric point: 9.5) was vacuum-deposited to form a third deposited layer having a thickness of 2 nm to obtain a double-deposited functional film 3.

The double-deposited functional film 3, the interlayer 1 and the glass plate were laminated in this order so that the third deposited layer of the double-deposited functional film 3 and the interlayer 1 were in contact with each other, and the laminate was put in a vacuum bag and heated in a hot air oven at 100° C. under 0.015 MPa [abs] for 30 minutes in a vacuum to conduct preliminary bonding. The preliminarily bonded laminate was put in an autoclave and heated at 130° C. under 1.0 MPa [abs] for 60 minutes to conduct main bonding thereby to obtain a laminate 1.

Laminates 2 to 4 were obtained in the same manner except that the interlayers 2 to 4 were used instead of the interlayer 1.

With respect to the laminates 1 to 4, the peel adhesion of the interface between the third deposited layer and the adhesive layer was evaluated. The results are shown in Table 1.

The coating fluid 1 was applied to the surface of the third deposited layer of the double-deposited functional film, dried at 90° C. for 4 minutes and irradiated with 1,000 mJ of ultraviolet rays to form a functional layer having a thickness of 10 μm thereby to obtain a coating film-provided functional film 1.

The coating fluid 2 was applied to the surface of the third deposited layer of the double-deposited functional film and dried at 90° C. for 4 minutes to form a functional layer having a thickness of 5 μm thereby to obtain a coating film-provided functional film 2.

The coating film 3 was applied to the surface of the third deposited layer of the double-deposited functional film and dried at 95° C. for 3 minutes to form a functional layer having a thickness of 5 μm thereby to obtain a coating film-provided functional film 3.

With respect to the coating film-provided functional films 1 to 3, the adhesion of the coating film to the third deposited layer was evaluated. The results are shown in Table 1.

### EX. 4

A functional film 2 was obtained in the same manner as in Ex. 1. NiO (isoelectric point: 10.3) was vacuum-deposited on the surface of the functional layer of the functional film 2 to form a third deposited layer having a thickness of 2 nm to obtain a double-deposited functional film 4.

Coating film-provided functional films 1 to 3 and laminates 1 to 4 were obtained and evaluated in the same manner as in Ex. 3 except that the double-deposited functional film 4 was used. The results are shown in Table 1.

### EX. 5

A functional film 3 was obtained in the same manner as in Ex. 1. Al₂O₃ (isoelectric point: 9.1) was vacuum-deposited on the surface of the functional layer of the functional film 3 to form a third deposited layer having a thickness of 2 nm thereby to obtain a double-deposited functional film 5.

Coating film-provided functional films 1 to 3 and laminates 1 to 4 were obtained and evaluated in the same manner as in Ex. 3 except that the double-deposited functional film 5. The results are shown in Table 1.

### EX. 6

Cr₂O₃ (isoelectric point: 6.5) was vacuum-deposited on both sides of the PET film to form a first deposited layer and a second deposited layer each having a thickness of 2 nm to obtain a double-deposited PET film 6.

Functional films 1 to 3 and laminates 1 to 4 were obtained and evaluated in the same manner as in Ex. 1 except that the double-deposited PET film 6 was used. The results are shown in Table 1.

### EX. 7

Functional films 1 to 3 and laminates 1 to 4 were obtained in the same manner as in Ex. 1 except that no first deposited layer nor second deposited layer were formed on both sides of the PET film.

With respect to the laminates 1 to 4, the peel adhesion of the interface between the PET film and the adhesive layer was evaluated. The results are shown in Table 1.

With respect to the functional films 1 to 3, the adhesion of the functional layer to the PET film was evaluated. The results are shown in Table 1.

### EX. 8

A functional film 1 was obtained in the same manner as in Ex. 7.

The functional film 1, the interlayer 1 and the glass plate were laminated in this order so that the functional layer of the functional film 1 and the interlayer 1 were in contact with each other, and the laminate was put in a vacuum bag and heated in a hot air oven at 100° C. under 0.015 MPa [abs] for 30 minutes in a vacuum to conduct preliminary bonding. The preliminarily bonded laminate was put in an autoclave and heated at 130° C. under 1.0 MPa [abs] for 60 minutes to conduct main bonding to obtain a laminate 1.

Laminates 2 to 4 were obtained in the same manner except that the interlayers 2 to 4 were used instead of the interlayer 1.

With respect to the laminates 1 to 4, the peel adhesion of the interface between the functional layer and the adhesive layer was evaluated. The results are shown in Table 1.

### EX. 9

A functional film 2 was obtained in the same manner as in Ex. 7.

Laminates 1 to 4 were obtained in the same manner as in Ex. 8 except that the functional film 2 was used.

With respect to the laminates 1 to 4, the peel adhesion of the interface between the functional layer and the adhesive layer was evaluated. The results are shown in Table 1.

### EX. 10

A functional film 3 was obtained in the same manner as in Ex. 7.

Laminates 1 to 4 were obtained in the same manner as in Ex. 8 except that the functional film 3 was used.

With respect to the laminates 1 to 4, the peel adhesion of the interface between the functional layer and the adhesive layer was evaluated. The results are shown in Table 1.

TABLE 1

| | | Peel adhesion (180° peel test) | | | | |
|---|---|---|---|---|---|---|
| | | | Adhesive layer (interlayer) | | | |
| Ex. | Layer structure of functional film | Layer evaluated | PVB | EVA | ion | COP |
| 1 | Al₂O₃/PET/Al₂O₃/functional layer (coating film) | First deposited layer (Al₂O₃) | A | A | A | A |
| 2 | SiO₂/PET/SiO₂/functional layer (coating film) | First deposited layer (SiO₂) | A | A | C | B |
| 3 | Al₂O₃/PET/Al₂O₃/UV (functional layer)/CuO | Third deposited layer (CuO) | A | A | A | A |
| 4 | Al₂O₃/PET/Al₂O₃/COP (functional layer)/NiO | Third deposited layer (NiO) | A | A | A | A |
| 5 | Al₂O₃/PET/Al₂O₃/PVB (functional layer)/Al₂O₃ | Third deposited layer (Al₂O₃) | A | A | A | A |
| 6 | Cr₂O₃/PET/Cr₂O₃/functional layer (coating film) | First deposited layer (Cr₂O₃) | C | A | D | B |
| 7 | PET/functional layer (coating film) | PET | D | A | D | B |
| 8 | PET/UV (functional layer) | UV (functional layer) | D | B | D | B |
| 9 | PET/COP (functional layer) | COP (functional layer) | B | A | D | A |
| 10 | PET/PVB (functional layer) | PVB (functional layer) | A | A | D | D |

Adhesion (cross-cut test)

Coating film

| Ex. | Layer evaluated | UV | COP | PVB |
|---|---|---|---|---|
| 1 | Second deposited layer (Al₂O₃) | A | A | A |
| 2 | Second deposited layer (SiO₂) | A | A | A |
| 3 | Third deposited layer (CuO) | A | A | A |
| 4 | Third deposited layer (NiO) | A | A | A |
| 5 | Third deposited layer (Al₂O₃) | A | A | A |
| 6 | Second deposited layer (Cr₂O₃) | D | D | C |
| 7 | PET | D | D | B |
| 8 | — | — | — | — |
| 9 | — | — | — | — |
| 10 | — | — | — | — |

UV: Cured product of ultraviolet curable resin
ion: Ionomer

### INDUSTRIAL APPLICABILITY

The functional laminated glass of the present invention is useful, for example, as a transparent screen, a heat reflective laminated glass or a design laminated glass.

This application is a continuation of PCT Application No. PCT/JP2019/051009, filed on Dec. 25, 2019, which is based upon and claims the benefit of priority from Japanese Patent Application No. 2018-243655 filed on Dec. 26, 2018. The contents of those applications are incorporated herein by reference in their entireties.

### REFERENCE SYMBOLS

10 transmission image display film, 11 transparent film, 12 light scattering layer, 13 first deposited layer, 14 second deposited layer, 15 third deposited layer, 16 transparent resin, 17 light scattering material, 20, 20A reflective image display film, 21 transparent film, 22 light scattering layer, 23 first deposited layer, 24 second deposited layer, 25 third deposited layer, 26 first transparent resin layer, 26a uncured film, 27 reflective film, 28 contact layer, 29 second transparent resin layer, 29a uncured film, 30 heat reflective film, 31 transparent film, 32 heat reflective layer, 33 first deposited layer, 34 second deposited layer, 35 third deposited layer, 36 high refractive index layer, 37 low refractive index layer, 40 design film, 41 transparent film, 42 printed layer, 43 first deposited layer, 44 second deposited layer, 45 third deposited layer, 50 transmission transparent screen, 52 first transparent substrate, 54 second transparent substrate, 56 first adhesive layer, 58 second adhesive layer, 60, 60A reflective transparent screen, 62 first transparent substrate, 64 second transparent substrate, 66 first adhesive layer, 68 second adhesive layer, 70 heat reflective laminated glass, 72 first transparent substrate, 74 second transparent substrate, 76 first adhesive layer, 78 second adhesive layer, 80 design laminated glass, 82 first transparent substrate, 84 second transparent substrate, 86 first adhesive layer, 88 second adhesive layer, 100 projector, F release film, L image light, M mold, S1 first surface, S2 second surface, X observer.

What is claimed is:

1. A functional laminated glass comprising:
a first transparent substrate,
a first adhesive layer,
a functional film comprising a substrate film and at least one functional layer containing an organic material, which has a deposited layer formed of an inorganic oxide having an isoelectric point of at most 6 or at least 7.4 as measured by streaming potential method, either one of or both on the outermost surface of the functional film and between the substrate film and the functional layer,
a second adhesive layer, and
a second transparent substrate,
laminated in this order.

2. The functional laminated glass according to claim 1, wherein the functional film has the deposited layer both on the outermost surface of the functional film and between the substrate film and the functional layer.

3. The functional laminated glass according to claim 1, wherein the deposited layer has a thickness of at most 100 nm.

4. The functional laminated glass according to claim 1, wherein the deposited layer is a single layer.

5. The functional laminated glass according to claim 1, wherein the inorganic oxide is at least one member selected from the group consisting of α-Al₂O₃, γ-Al₂O₃, CuO, NiO, SiO₂ and TiO₂.

6. The functional laminated glass according to claim 5, wherein the inorganic oxide is α-Al₂O₃.

7. The functional laminated glass according to claim 1, wherein the inorganic oxide has an isoelectric point of at least 7.4.

8. The functional laminated glass according to claim 7, wherein the inorganic oxide has an isoelectric point of at least 9.

9. The functional laminated glass according to claim 1, wherein the functional layer is at least one member selected from the group consisting of an image display layer, a heat reflective layer, a design layer, a protective layer, an ultraviolet absorbing layer, a light controlling layer and a polymer dispersed liquid crystal layer.

10. The functional laminated glass according to claim 9, wherein the functional layer is an image display layer.

11. The functional laminated glass according to claim 1, wherein the first adhesive layer and the second adhesive layer comprise at least one member selected from the group consisting of a polyvinyl acetal resin, an ethylene/vinyl acetate copolymer, an ionomer and a cycloolefin polymer.

12. The functional laminated glass according to claim 2, wherein the peel adhesion of the interface between the deposited layer and the first adhesive layer or the second adhesive layer, obtained in accordance with JIS A 5759 (2016), is at least 4 N/25 mm.
